(19) United States
(12) Patent Application Publication
(10) Pub. No.: US 2021/0216871 A1
(43) Pub. Date: Jul. 15, 2021

(54) Fast Convolution over Sparse and Quantization Neural Network

(71) Applicant: Intel Corporation, Santa Clara, CA (US)

(72) Inventors: Yu Zhang, Beijing (CN); Huifeng LE, Shanghai (CN); Richard CHUANG, Chandler, AZ (US); Metz WERNER, Jr., Chandler, AZ (US); Heng Juen HAN, Shanghai (CN); Ning ZHANG, Beijing (CN); Wenjian SHAO, Shanghai (CN); Ke HE, Beijing (CN)

(73) Assignee: Intel Corporation, Santa Clara, CA (US)

(21) Appl. No.: 17/256,121

(22) PCT Filed: Sep. 7, 2018
(86) PCT No.: PCT/CN2018/104539

§ 371 Date: Dec. 24, 2020

(51) Int. Cl. G06N 3/08; G06N 3/04

(52) U.S. Cl. CPC G06N 3/08; G06N 3/04

(57) ABSTRACT

Processes and systems are disclosed. The processes and systems are arranged to apply convolution for a CNN where the CNN is simplified using sparse techniques, quantization techniques or both sparse and quantization techniques. A location vector (LV) table is provided to record the coordinates of non-zero weights. A look up table is provided to recover the real weight value from the weight identification. Convolution is applied by retrieving the coordinates of the next non-zero weight and the associated real weight value and by accumulating the multiplication of the real weight value and the input value across the input activation plane.

### TECHNICAL FIELD

Embodiments described herein relate to the field of neural networks. More specifically, the embodiments relate to methods and apparatuses for applying convolution over sparse and quantization neural networks.

### BACKGROUND

Neural networks (NNs) are tools for solving complex problems across a wide range of domains such as computer vision, image recognition, speech processing, natural language processing, language translation, and autonomous vehicles. One example of an NN is a convolutional neural network (CNN). In general, CNNs include a convolutional layer, an activation layer, and a full connection layer. Convolution is a computation-intensive operation for NN models. As such, the bulk of the processing requirements for CNNs is due to the convolution layer. Deployment of CNNs in real systems is a challenge due to the large computing resource requirements for CNNs.

### BRIEF DESCRIPTION OF THE DRAWINGS

FIG. 1 illustrates an embodiment of an example computing system.

FIG. 2 illustrates an embodiment of an example convolution with element filter over input plane to produce an output plane.

FIG. 3 illustrates an embodiment of an example weight space.

FIG. 4 illustrates an embodiment of a first example logic flow.

FIG. 5 illustrates an embodiment of a second example logic flow.

FIG. 6 illustrates an embodiment of a third example logic flow.

FIG. 7 illustrates an embodiment of an example data processing system.

FIG. 8 illustrates an embodiment of a storage medium.

FIG. 9 illustrates an embodiment of a system.

### DETAILED DESCRIPTION

Embodiments disclosed herein provide a CNN where convolution is applied over sparse or quantization NNs. Said differently, the present disclosure provides for a simplified activation and full connection layer for the CNN and then applies the convolution over these simplified layers. In various implementations, the CNN can be simplified using either or both sparse and quantization compression techniques. In general, sparse network compression is achieved where weights within the network, which have no contribution to the output, are assigned a zero-value. Whereas, quantization network compression is achieved where the weight space is classified into several weight groups, each of which can be represented by a weight ID.

It is noted, that the present disclosure provides a significant advantage over conventional CNNs, in that computing workload and storage requirements can be reduced significantly, due to the underlying compression of the network. Said differently, due to sparse and quantization compression techniques used to simplify layers of the CNN, the computing and storage requirements needed to apply convolution over the layers is reduced. It is also important to note that one cannot merely swap out compressed network levels for the activation and full connection layers of a CNN to achieve the results of the present disclosure. Part of this is due to that fact that the operation of the convolution is modified significantly from conventional techniques. It is with respect to these modifications that the present disclosure is directed.

Generally, embodiments disclosed herein provide convolution for a CNN that is optimized and/or specifically arranged for sparse and quantization networks. Some implementations provide a location vector (LV) table to record the coordinates of non-zero weights. Calculations related to any zero weights are removed from convolution. As such, the convolution workload and storage requirements may be reduced. With the reduction in workload and storage requirements, complex CNNs can be deployed in more real-world applications. For example, CNNs implemented according to the present disclosure could be deployed on resource restricted hardware devices, such as, edge computing device in an IoT system.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

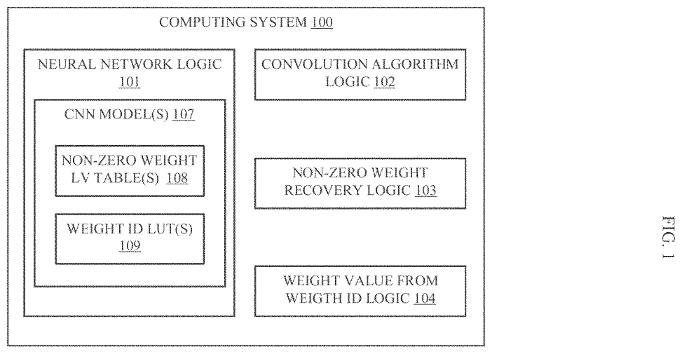

FIG. 1 illustrates an embodiment of a computing system 100. The computing system 100 is representative of any number and type of computing systems, such as a server, workstation, laptop, a virtualized computing system, an edge computing device, or the like. For example, the computing system 100 may be an embedded system such as a deep learning accelerator card, a processor with deep learning acceleration, a neural compute stick, or the like. In some examples, the computing system 100 comprises a System on a Chip (SoC), while in other embodiments, the computing system 100 includes a printed circuit board or a chip package with two or more discrete components. As shown, the computing system 100 includes a neural network logic 101, a convolution algorithm logic 102, a non-zero weight recovery logic 103, and a weight value from weight identification (ID) logic 104.

The neural network logic 101 is representative of hardware, software, and/or a combination thereof, which may comprise a neural network (e.g., a DNN, a CNN, etc.) that implements dynamic programing to determine and solve for an approximated value function. In at least one embodiment, the neural network logic 101 comprises one or more CNNs, referenced as CNN model(s) 107. Each CNN model 107 is formed of a cascade of multiple layers of nonlinear processing units for feature extraction and transformation. Each successive layer of the CNN uses the output from the previous layer as input. The CNN may generally include an input layer, an output layer, and multiple hidden layers. The hidden layers of a CNN may include convolutional layers, pooling layers, fully connected layers, and/or normalization layers. It is noted, that reference herein to CNN model 107 (e.g., singular) or CNN models 107 (e.g., plural) is used based on context and not intended to imply a singular or plural model unless specifically noted or indicated from the context of use.

Generally, a neural network includes two processing phases, a training phase and an inference phase. During training, a deep learning expert will typically architect the network, establish the number of layers in the neural network, the operation performed by each layer, and the connectivity between layers. Many layers have parameters, typically filter weights, that determine the exact computation performed by the layer. The objective of the training process is to learn the filter weights, usually via a stochastic gradient descent-based excursion through the space of weights. The training phase generates an output feature map, also referred to as an activation tensor. An activation tensor may be generated for each convolutional layer of the CNN model 107. The output feature map of a given convolutional layer may be the input to the next convolutional layer. Once the training process is complete, inference based on the trained neural network typically employs a forward-propagation calculation for input data to generate output data. As will be described in greater detail below, these forward-propagation calculations employ a non-zero weight location vector (LV) table 108 and/or a weight ID look up table (LUT) 109.

In various implementations, the computing system 100 may provide the neural network logic 101 with cascaded stages for face detection, character recognition, speech recognition, or the like. The neural network logic 101 may then perform training based on an input dataset (e.g., images of faces, handwriting, printed information, etc.) that is in the form of tensor data. A tensor is a geometric object that describes linear relations between geometric vectors, scalars, and other tensors. An organized multidimensional array of numerical values, or tensor data, may represent a tensor. The training may produce refined weights for the neural network logic 101. For example, the refined weights may specify features that are characteristic of numerals and/or each letter in the English alphabet. These refined weights may be simplified as described above. For example, sparse network compression may be applied to the trained network to remove weights with zero-value contribution to the network output. As another example, quantization network compression may be applied to the trained network to group the weight space into several classifications, each of which can be represented by a weight ID. With some examples, both sparse and quantization compression techniques can be applied to the trained network.

During the inference phase, the neural network logic 101 may receive images as input and perform desired processing on the input images. For example, the input images may depict handwriting, and the trained neural network logic 101 may identify numerals and/or letters of the English alphabet included in the handwriting. It is during this inference phase that the convolution of the compressed network is handled.

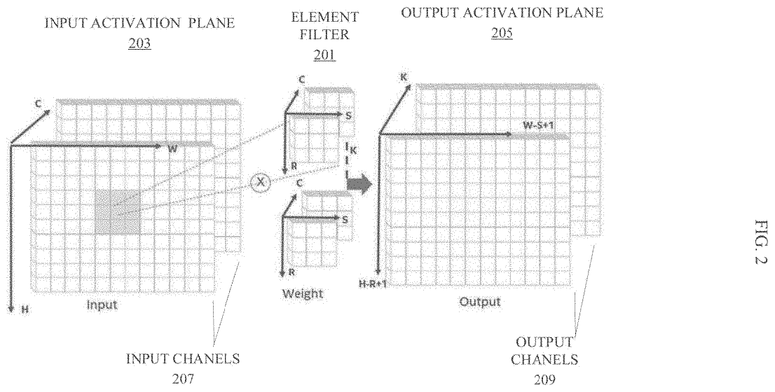

Normal convolution involves a two-dimensional (2D) a sliding-window convolution. For example, FIG. 2 depicts a 2D sliding-window convolution of an S×R element filter 201 over a W×H element input activation plane 203 to produce a (W−S+1)×(H−R+1) element output activation plane 205. The data can include C input channels 207. A distinct filter 201 may be applied to each channel 207 of the input activation plane 203, and the filter output for each of the channels 207 can be accumulated together, element-wise into a single output activation channel 209. Multiple filters (K) can be applied to the same volume of input activations (e.g., channels 207 of input activation planes 203) to produce K output channels 209. In traditional convolution, the input activation plane 203 and element filter 201 are scanned sequentially. It is to be appreciated that this will include unnecessary computing, for example, when zero weight values are involved in the calculation.

The convolution algorithm logic 102 is hardware, software, and/or a combination thereof that implements one or more versions of a convolution algorithm, according to various examples of the present disclosure. Non-zero weight LV table(s) 108 are provided, which indicate the coordinates of non-zero quantization filter weights. During operation, or convolution, calculations related to any filter weights with a zero-value can then be removed. It is to be appreciated, that the actual convolution computation is independent from the removal of non-zero weights from convolution. For example, the present disclosure can be applied independent of the underlying sparse or quantization algorithm.

Due to the removal of non-zero weights from convolution, the convolution workload will be reduced. A further result from this is that the computing power and storage requirements needed to execute the convolution algorithm logic 102 is reduced, thus effectively “lowering the bar” needed to run a complex CNN on a resource restricted hardware device, such as edge computing device in IoT systems.

In general, the present disclosure provides a non-zero weight LV table 108, which indicates the “sparsity” of the network weights or indicates the locations of non-zero weights. During convolution, the locations are retrieved, and convolution is applied over only these non-zero weights. An example of indicating sparsity information is given below.

With some examples, sparsity information for a three-dimensional (3D) element filter can be indicated by a LV table where each entry of the table is 1 byte long and indicates the relative coordinates of the next non-zero weight respective to the current non-zero weight. If the relative coordinate of the next non-zero weight is beyond the range that 1-byte can represent, an intermediate hop (pseudo point) may be placed in the LV table. The intermediate hop can be indicated with a label and will not be used for convolution. More particularly, for a 3D element filter having the plane (X,Y,Z), 0≤X≤S, 0≤Y≤R, 0≤Z≤C, a LV table couple be provided based on the following format.

TABLE 1
Example Location Vector Table Format

| Bit | | | | | | | | |
|---|---|---|---|---|---|---|---|---|
| 7 | 6 | 5 | 4 | 3 | 2 | 1 | 0 | Description |
| 1 | 1 | ΔZ | | Y | | X | | Next point is intermediate hop in different channel |
| | | | | | | | | [5:4]: ΔZ |
| | | | | | | | | [3:2]: Y value for next weight point |
| | | | | | | | | [1:0]: X value for next weight point |
| 1 | 0 | ΔY | | Distance | | | | Next point is intermediate hop in the same channel |
| | | | | | | | | [5:4]: ΔY |
| | | | | | | | | [3:0]: intermediate hop distance from current point |
| | | | | | | | | in weight space |
| 0 | 1 | ΔZ | | Y | | X | | Next point is non-zero hop in different channel |
| | | | | | | | | [5:4]: ΔZ |
| | | | | | | | | [3:2]: Y value for next weight point |
| | | | | | | | | [1:0]: X value for next weight point |
| 0 | 0 | ΔY | | Distance | | | | Next point is non-zero hop in the same channel |
| | | | | | | | | [5:4]: ΔY |
| | | | | | | | | [3:0]: next point distance from current point |
| | | | | | | | | in weight space |

In some examples, a LV table can be provided for each filter (e.g., filter 201) used for convolution.

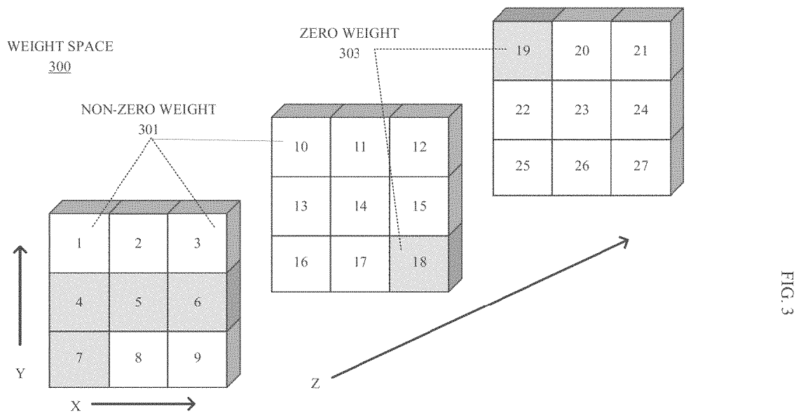

FIG. 3 depicts an example weight space 300, with dimensions X, Y, Z. The example weight space 300 shows weights 1 through 27, where weights 4, 5, 6, 7, 18, and 19 are zero. A couple of the non-zero weights 301 and a couple of the zero valued weights 303 are pointed out in this figure. Additionally, the zero values weights (e.g., weights 4, 5, 6, 7, 18, and 19) are shaded darker than the non-zero weights. Using the example weight space 300, a LV table could be provided using the format from Table 1. In such an example LV table, entries would be [0, 0, 2, 5] corresponding to weight 8 and [0, 1, 1, 0, 1] corresponding to weight 20.

During operation, convolution may be accomplished by sliding the filter within the input activation plane. The multiplication of filter weights and input activations at the same location within the sliding window will be accumulated to generate the filter output. However, as the present disclosure records the sparsity information (e.g., location of non-zero weights) using the non-zero weight LV tables 108, only non-zero filter weights have a contribution to the filter output. Thus, convolution only needs to calculate the multiplication related to non-zero filter weights. To complete the multiplication, the address of input activations related to non-zero weights needs to be recovered. The recovery of the input activations can be accomplished using the LV table.

For example, non-zero weight recovery logic 103 can recover the next non-zero weight from the input activation plane 203 while convolution algorithm logic 102 generates the output activation plane 205 from the recovered non-zero weights and the element filter 201.

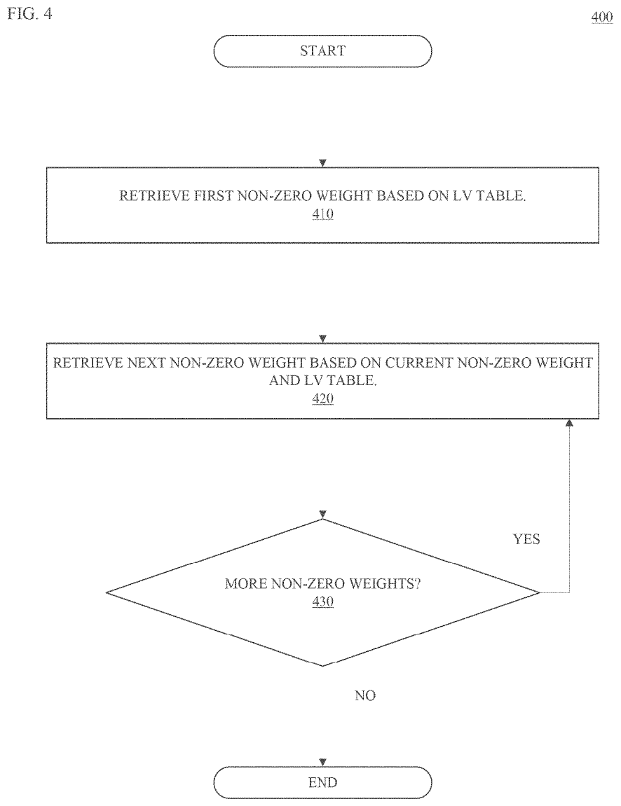

FIG. 4 illustrates an embodiment of a logic flow 400. The logic flow 400 may be representative of some or all the operations executed by one or more embodiments described herein. For example, the computing system 100 (or components thereof) may perform the operations in logic flow 400 to recover the address of the input activations related to non-zero weights. Logic flow 400 is described with respect to an example network where input activations and filter weights are stored in a continuous memory space.

Logic flow 400 may begin at block 410 “Retrieve first non-zero weight based on LV table” the first non-zero weight can be retrieved from the LV table. For example, LV table 108 could be sued to identify and retrieve the first non-zero weight. Assuming “Input_Row_Size” and “Input_Col_Size” represent the row size and column size of the input activation plane 203, respectively; and assuming that “Weight_Row_Size” and “Weight_Col_Size” represent the row size and column size of the element filter 201, respectively; one can use (Xₙ, Yₙ, Zₙ) and (Xₙ₊₁, Yₙ₊₁, Zₙ₊₁) to represent the coordinates of 2 points in a sliding window that are related to 2 consecutive non-zero weights in the filter weight plane. Their locations in sliding window can represented as illustrates in Table 2.

TABLE 2
Example locations of non-zero weights in a sliding window.

| | | |
|---|---|---|
| Xₙ, Yₙ, Zₙ | 0 | 0 |
| 0 | Xₙ₊₁, Yₙ₊₁, Zₙ₊₁ | 0 |
| 0 | 0 | 0 |

In some examples, the memory address of the first input activation (X₀, Y₀, Z₀) within the channel can be calculated from the location of the sliding window, the channel number, and the LV table. With some examples, non-zero weight recovery logic 103 retrieves the location and/or value of the first non-zero weight for the CNN model 107 based on the non-zero weight LV table 108.

Continuing to block 420 “Retrieve next non-zero weight based on current non-zero weight and LV table” the next non-zero weight can be retrieved using the current non-zero weight and the LV table. Let I(Xₙ, Yₙ, Zₙ) represent the memory address for input activation (Xₙ, Yₙ, Zₙ) and W(Xₙ, Yₙ, Zₙ) represent the location for weight point (Xₙ, Yₙ, Zₙ). Assuming (Xₙ, Yₙ, Zₙ) and (Xₙ₊₁, Yₙ₊₁, Zₙ₊₁) are in the same channel, then:

$$I ( {X}_{n + 1} , {Y}_{n + 1} , {Z}_{n + 1} ) = I ( {X}_{n} , {Y}_{n} , {Z}_{n} ) + ( {X}_{n + 1} - {X}_{n} ) + ( {Y}_{n + 1} - {Y}_{n} ) \times Input\_Row \_Size ;$$

$$W ( {X}_{n + 1} , {Y}_{n + 1} , {Z}_{n + 1} ) = W ( {X}_{n} , {Y}_{n} , {Z}_{n} ) + ( {X}_{n + 1} - {X}_{n} ) + ( {Y}_{n + 1} - {Y}_{n} ) \times Weight\_Row \_Size ; and I ( {X}_{n + 1} , {Y}_{n + 1} , {Z}_{n + 1} ) \\ = I ( {X}_{n} , {Y}_{n} , {Z}_{n} ) + ( W ( {X}_{n + 1} , {Y}_{n + 1} , {Z}_{n + 1} ) - W ( {X}_{n} , {Y}_{n} , {Z}_{n} ) ) + ( {Y}_{n + 1} - {Y}_{n} ) \times ( Inpu {t}_{R o {w}_{Size}} - Weigh {t}_{R o {w}_{Size}} )$$

Equation 1: Example recovery of input activation coordination from weight coordination Since W(Xₙ₊₁, Yₙ₊₁, Zₙ₊₁)−W(Xₙ, Yₙ, Zₙ) is represented as “Distance” in the LV Table, Yₙ₊₁−Yₙ is represented as “ΔY” in the LV Table, and Input_Row_Size and Weight_Row_Size are constant, memory address of input activation (Xₙ₊₁, Yₙ₊ᵢ, Zₙ₊₁) can be recovered from the memory address of (Xₙ, Yₙ, Zₙ) and the LV table. Furthermore, as Distance and ΔY are both positive numbers, sign extension during the calculation can be avoided, thus simplifying the calculation. With some examples, non-zero weight recovery logic 103 retrieves the location and/or value of the next non-zero weight for the CNN model 107 based on the current non-zero weight and the non-zero weight LV table 108. It is noted, that in some examples, the location for the next non-zero weight may specific a memory address comprising an indication of a real weight values. In other examples, the location for the next non-zero weight may specific a memory address comprising an indication of a weight ID.

Continuing to decision block 430 “More non-zero weights?” a determination of whether more non-zero weights need to be recovered is made. In some examples, the non-zero weight recovery logic 103 determines whether more non-zero weights are to be recovered based on whether further entries in the LV table 108 exist and/or whether further weights exist in the CNN model 107. Based on a determination that more non-zero weights need to be recovered, logic flow 400 can return to block 420. Based on a determination that no more non-zero weights need to be recovered, logic flow 400 can end.

As detailed above, with some examples, convolution can be applied to networks simplified using quantization algorithms, such as, where the weight space is grouped into classifications. In such an example, weight value from weight ID logic 104 can recover the weight value from the weight ID and the weight ID LUT 109 while convolution algorithm logic 102 generates the output activation plane 205 from the recovered weight value and the element filter 201.

With some examples, each weight ID is 1-byte long for networks simplified using quantization techniques. In such an example, a weight ID LUT 109 could include 256 entries, where each entry is 2-bytes long for floating point (fp) 16 or 4-bytes for fp32 networks. It is to be appreciated, that in the weight plane, only the weight ID is stored. Thus, quantization of the network will save memory space for weight storage if the weight value is more than 1-byte long, such as is the case with fp16 and fp32 networks. Tables 3, 4 and 5 illustrates an example of quantization.

TABLE 3
Example original weight plane.

| Y/X | 0/0 | 0/1 | 0/2 | 1/0 | 1/1 | 1/2 | 2/0 | 2/1 | 2/2 |
|---|---|---|---|---|---|---|---|---|---|
| CH0 | 0 | −3.0 | 3.0 | 0 | 0 | 6.0 | 0 | 3.0 | 0 |
| CH1 | 8.0 | −3.0 | 0 | 3.0 | −5.0 | −5.0 | 0 | −5.0 | −9.0 |
| CH2 | 0 | −9.0 | 3.0 | 8.0 | 0 | −9.0 | 0 | −3.0 | 3.0 |

TABLE 4
Example weight value LUT.

| A | B | C | D | E | F |
|---|---|---|---|---|---|
| −9.0 | −5.0 | −3.0 | 3.0 | 6.0 | 8.0 |

TABLE 5
Example compressed weight plane.

| | | | | | | | | | | | | | | | | |
|---|---|---|---|---|---|---|---|---|---|---|---|---|---|---|---|---|
| C | D | E | D | F | C | D | B | B | B | A | A | D | F | A | C | D |

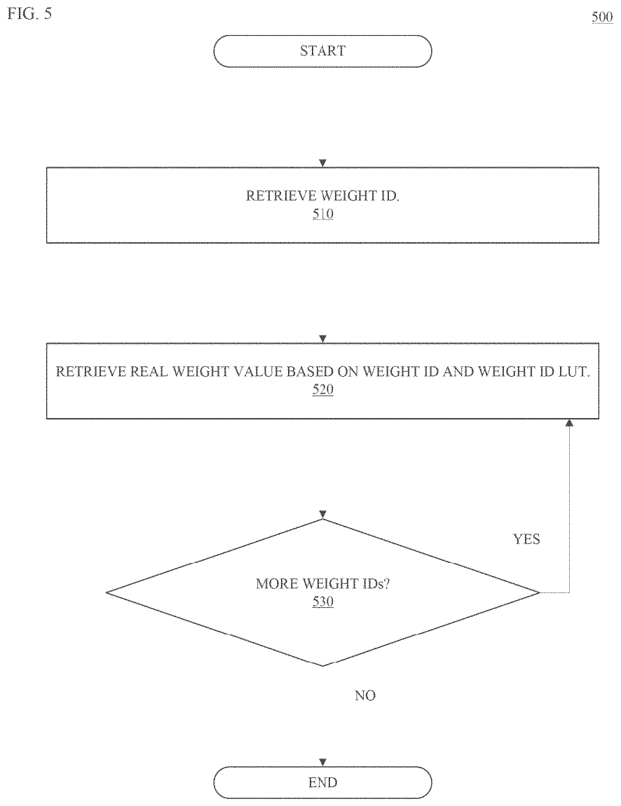

FIG. 5 illustrates an embodiment of a logic flow 500. The logic flow 500 may be representative of some or all the operations executed by one or more embodiments described herein. For example, the computing system 100 (or components thereof) may perform the operations in logic flow 500 to recover the real weight value from a weight ID. In some examples, the weight ID for the next non-zero weight can be recovered using, for example, logic flow 400. Logic flow 500 may begin at block 510 “retrieve weight ID” where the weight ID is retrieved. The weight ID for the next non-zero weight can be recovered using, for example, logic flow 400. For example, non-zero weight recovery logic 103 can retrieve the weight ID for the next non-zero weight as described herein.

Continuing to block 520 “retrieve real weight value based on weight ID and weight ID LUT” the real weight value can be retrieved from the weight ID LUT 109 using the weight ID. For example, weight value from weight ID logic 104 can look up the real weight value in the weight ID LUT 109 using the retrieved weight ID.

Continuing to decision block 530 “More weight IDs?” a determination of whether more weight IDs need to be processed. In some examples, the weight value from weight ID logic 104 determines whether more weight IDs are to be processed. Based on a determination that more weight IDs need to be processed, logic flow 500 can return to block 520. Based on a determination that no more weight IDs need to be processed, logic flow 500 can end.

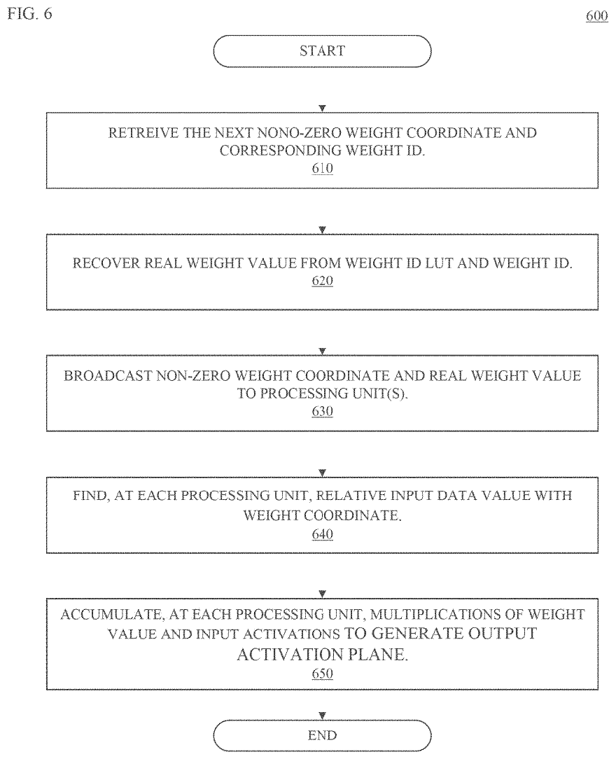

FIG. 6 illustrates an embodiment of a logic flow 600. The logic flow 600 may be representative of some or all the operations executed by one or more embodiments described herein. For example, computing system 100 (or components thereof) may perform the operations in logic flow 600 to process input activations for sparse and/or quantized networks.

Logic flow 600 may begin at block 610 “Retrieve next non-zero weight coordinate and corresponding weight ID” the next non-zero weight coordinate and corresponding weight ID is retrieved. Non-zero weight recovery logic 103 can retrieve the next non-zero weight coordinate corresponding weight ID. For example, non-zero weight recovery logic 103 can retrieve the next non-zero weight coordinate corresponding weight ID using a process like outlined in logic flow 400.

Continuing to block 620 “Recover real weight value from weight ID LUT and weight ID” the real weight value is recovered based on the weight ID LUT and the weight ID. Weight value from weight ID logic 104 can recover the real weight value. For example, weight value from weight ID logic 104 can recover the real weight value using a process like outlined in logic flow 500.

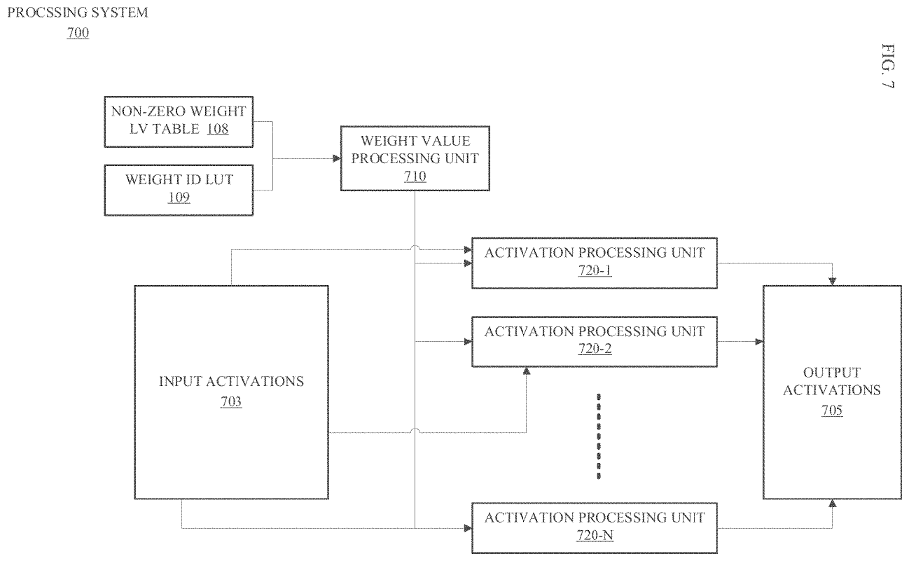

Continuing to block 630 “Broadcast non-zero weight coordinate and real weight value to processing unit(s)” the non-zero weight coordinate and real weight value is broadcast to processing units. For example, convolution logic 102 can broadcast the non-zero weight coordinate and real weight value to processing units arranged to process the input activation plane 203 and element filter 201 to generate the output activation plane 205. An example of such processing units is given in FIG. 7.

Continuing to block 640 “Find, at each processing unit, relative input data value with weight coordinate” each processing unit can find the relative input data value with the weight coordinate. For example, each processing unit (e.g., activation processing units 720 depicted in FIG. 7) can each coordination of input data that will contribute to output activations can be retrieved from it's element-wise weight contribution based on Equation 1.

Continuing to block 650 “Accumulate, at each processing unit, multiplications of weight value and input activations to generate output activation plane” each processing unit can accumulate the multiplication of the real weight value and the input activations to generate the output activation plane. For example, each processing unit (e.g., activation processing units 720 depicted in FIG. 7) can accumulate the outputs from applying the element filter over the input activation plane (e.g., the multiplication of the real weight value and the input activations retrieved at block 640).

FIG. 7 illustrates an embodiment of an example processing system 700 arranged to compute convolutions over sparse and/or quantized networks as discussed herein. Processing system 700 includes weight value processing unit 710 and several activation processing units 720-n, where n is a positive integer, often greater than 1. This figure depicts activation processing unit 720-1, 720-2, and 720-n. However, in practice the processing system 700 can include any number of activation processing units.

In general, weight value processing unit 710 retrieves the next non-zero weight coordinate and the real weight value as detailed herein and forwards the coordinates and real weight value to the activation processing units 720-n. Each activation processing unit 720-n multiplies a vector of weights (e.g., as forwarded by weight value processing unit 710, or the like) and a vector of input activations 703. With some examples, each activation processing unit 710-n processes a dedicated area within the input activation plane 702. The set of activation processing units 720-n work together to process the whole input activation plane 703 and generate the output activation plane 705. With some examples, the processing system 700 could be formed from a field programmable gate array (FPGA). In other examples, the processing system 700 could be formed from an application specific integrated circuit (ASIC).

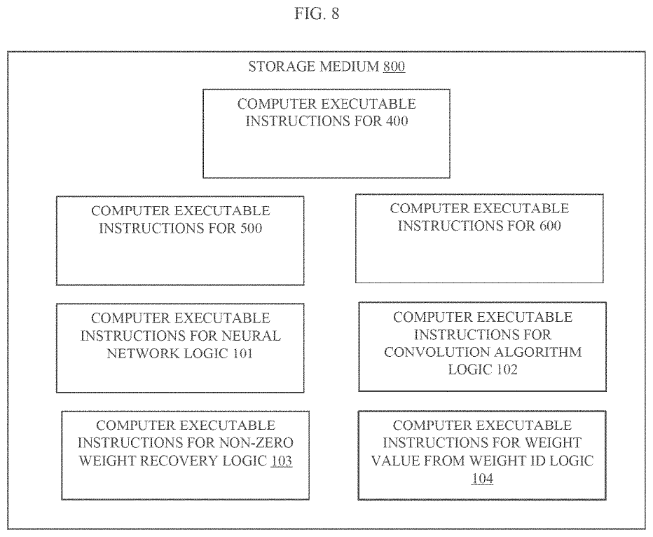

FIG. 8 illustrates an embodiment of a storage medium 800. Storage medium 800 may comprise any non-transitory computer-readable storage medium or machine-readable storage medium, such as an optical, magnetic or semiconductor storage medium. In various embodiments, storage medium 800 may comprise an article of manufacture. In some embodiments, storage medium 800 may store computer-executable instructions, such as computer-executable instructions to implement one or more of logic flows or operations described herein, such as with respect to 400, 500, and/or 600 of FIGS. 4-6. The storage medium 800 may further store computer-executable instructions for the neural network logic 101, convolution algorithm logic 102, non-zero weight recovery logic 103, and weight value from weight ID logic 104. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

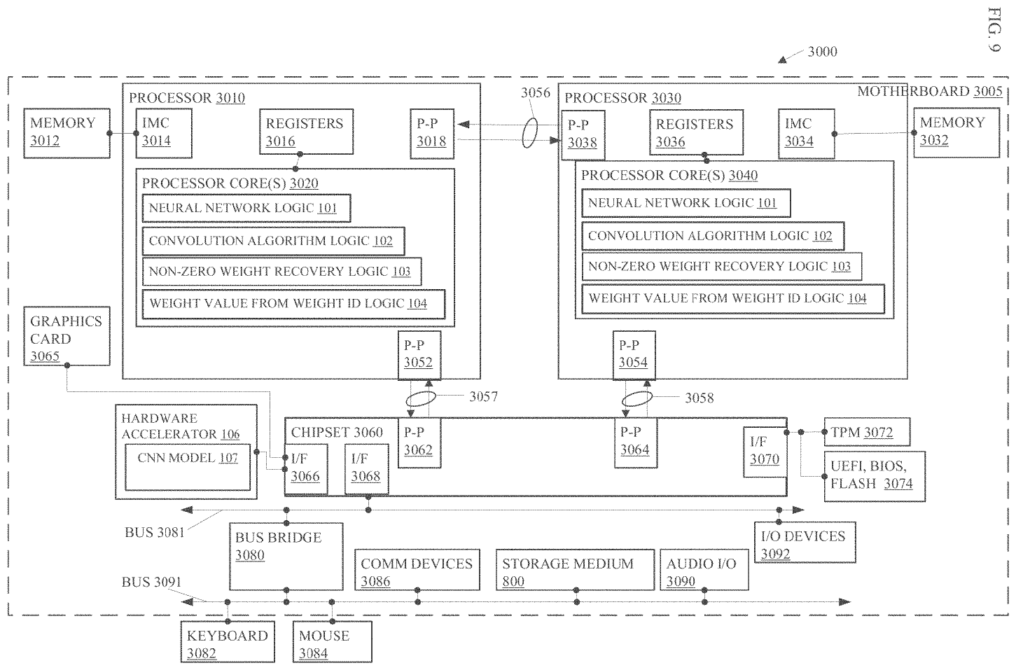

FIG. 9 illustrates an embodiment of a system 3000. The system 3000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 3000 may have a single processor with one core or more than one processor. Note that the term “processor” refers to a processor with a single core or a processor package with multiple processor cores. In at least one embodiment, the computing system 3000 is representative of the computing system 100. More generally, the computing system 3000 is configured to implement all logic, systems, logic flows, methods, apparatuses, and functionality described herein with reference to FIGS. 1-8.

As used in this application, the terms “system” and “component” and “module” are intended to refer to a computer-related entity, either hardware, a combination of hardware and software, software, or software in execution, examples of which are provided by the exemplary system 3000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in this figure, system 3000 comprises a motherboard 3005 for mounting platform components. The motherboard 3005 is a point-to-point interconnect platform that includes a first processor 3010 and a second processor 3030 coupled via a point-to-point interconnect 3056 such as an Ultra Path Interconnect (UPI). In other embodiments, the system 3000 may be of another bus architecture, such as a multi-drop bus. Furthermore, each of processors 3010 and 3030 may be processor packages with multiple processor cores including processor core(s) 3020 and 3040, respectively. While the system 3000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 3010 and the chipset 3060. Some platforms may include additional components and some platforms may only include sockets to mount the processors and/or the chipset.

The processors 3010, 3020 can be any of various commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi processor architectures may also be employed as the processors 3010, 3020.

The first processor 3010 includes an integrated memory controller (IMC) 3014 and point-to-point (P-P) interfaces 3018 and 3052. Similarly, the second processor 3030 includes an IMC 3034 and P-P interfaces 3038 and 3054. The IMC's 3014 and 3034 couple the processors 3010 and 3030, respectively, to respective memories, a memory 3012 and a memory 3032. The memories 3012 and 3032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 3012 and 3032 locally attach to the respective processors 3010 and 3030. In other embodiments, the main memory may couple with the processors via a bus and shared memory hub.

The processors 3010 and 3030 comprise caches coupled with each of the processor core(s) 3020 and 3040, respectively. In the present embodiment, the processor core(s) 3020 of the processor 3010 and the processor core(s) 3040 of processor 3030 include the neural network logic 101, convolution algorithm logic 102, non-zero weight recovery logic 103, and weight value from weight ID logic 104. The processor cores 3020, 3040 may further memory management logic circuitry (not pictured) which may represent circuitry configured to implement the functionality of the neural network logic 101, convolution algorithm logic 102, non-zero weight recovery logic 103, and weight value from weight ID logic 104 in the processor core(s) 3020, 3040, or may represent a combination of the circuitry within a processor and a medium to store all or part of the functionality of the neural network logic 101, convolution algorithm logic 102, non-zero weight recovery logic 103, and weight value from weight ID logic 104 in memory such as cache, the memory 3012, buffers, registers, and/or the like. In several embodiments, the functionality of the neural network logic 101, convolution algorithm logic 102, non-zero weight recovery logic 103, and weight value from weight ID logic 104 resides in whole or in part as code in a memory such as the storage medium 800 attached to the processors 3010 and/or 3030 via a chipset 3060. The functionality of the neural network logic 101, convolution algorithm logic 102, non-zero weight recovery logic 103, and weight value from weight ID logic 104 may also reside in whole or in part in memory such as the memory 3012 and/or a cache of the processor. Furthermore, the functionality of the neural network logic 101, convolution algorithm logic 102, non-zero weight recovery logic 103, and weight value from weight ID logic 104 may also reside in whole or in part as circuitry within the processor 3010 and may perform operations, e.g., within registers or buffers such as the registers 3016 within the processors 3010, 3030, or within an instruction pipeline of the processors 3010, 3030. Further still, the functionality of the neural network logic 101, the convolution logic 102, non-zero weight recovery logic 103, and weight value from weight ID logic 104 may be integrated a processor of the hardware accelerator 106 for performing convolution of a simplified (e.g., sparse, quantized, etc.) CNN model 107.

As stated, more than one of the processors 3010 and 3030 may comprise functionality of the neural network logic 101, convolution algorithm logic 102, non-zero weight recovery logic 103, and weight value from weight ID logic 104, such as the processor 3030 and/or a processor within the hardware accelerator 106 coupled with the chipset 3060 via an interface (I/F) 3066. The I/F 3066 may be, for example, a Peripheral Component Interconnect-enhanced (PCI-e).

The first processor 3010 couples to a chipset 3060 via P-P interconnects 3052 and 3062 and the second processor 3030 couples to a chipset 3060 via P-P interconnects 3054 and 3064. Direct Media Interfaces (DMIs) 3057 and 3058 may couple the P-P interconnects 3052 and 3062 and the P-P interconnects 3054 and 3064, respectively. The DMI may be a high-speed interconnect that facilitates, e.g., eight Giga Transfers per second (GT/s) such as DMI 3.0. In other embodiments, the processors 3010 and 3030 may interconnect via a bus.

The chipset 3060 may comprise a controller hub such as a platform controller hub (PCH). The chipset 3060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 3060 may comprise more than one controller hub such as a chipset with a memory controller hub, a graphics controller hub, and an input/output (I/O) controller hub.

In the present embodiment, the chipset 3060 couples with a trusted platform module (TPM) 3072 and the UEFI, BIOS, Flash component 3074 via an interface (I/F) 3070. The TPM 3072 is a dedicated microcontroller designed to secure hardware by integrating cryptographic keys into devices. The UEFI, BIOS, Flash component 3074 may provide pre-boot code.

Furthermore, chipset 3060 includes an I/F 3066 to couple chipset 3060 with a high-performance graphics engine, graphics card 3065. In other embodiments, the system 3000 may include a flexible display interface (FDI) between the processors 3010 and 3030 and the chipset 3060. The FDI interconnects a graphics processor core in a processor with the chipset 3060.

Various I/O devices 3092 couple to the bus 3081, along with a bus bridge 3080 which couples the bus 3081 to a second bus 3091 and an I/F 3068 that connects the bus 3081 with the chipset 3060. In one embodiment, the second bus 3091 may be a low pin count (LPC) bus. Various devices may couple to the second bus 3091 including, for example, a keyboard 3082, a mouse 3084, communication devices 3086 and the storage medium 700 that may store computer executable code as previously described herein. Furthermore, an audio I/O 3090 may couple to second bus 3091. Many of the I/O devices 3092, communication devices 3086, and the storage medium 800 may reside on the motherboard 3005 while the keyboard 3082 and the mouse 3084 may be add-on peripherals. In other embodiments, some or all the I/O devices 3092, communication devices 3086, and the storage medium 800 are add-on peripherals and do not reside on the motherboard 3005.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The following examples pertain to further embodiments, from which numerous permutations and configurations will be apparent.

Example 1. An apparatus, comprising: a processor; and a memory storing instructions, which when executed by the processor cause the processor to: retrieve coordinates for a non-zero weight of a convolutional neural network (CNN); and generate an output activation based on the coordinates for the non-zero weight of the CNN and an input activation.

Example 2. The apparatus of claim 1, the memory storing instructions, which when executed by the processor cause the processor to: access a non-zero weight location vector table to retrieve the coordinates for the non-zero weight; and retrieve a memory address associates with the non-zero weight.

Example 3. The apparatus of claim 2, the coordinates relative to a last non-zero weight.

Example 4. The apparatus of claim 3, the non-zero weight location vector table comprising indications of a plurality of non-zero weights, each indication comprising 1-byte.

Example 5. The apparatus of any one of claims 2 to 4, the memory address comprising an indication of a weight identification (ID), the memory storing instructions, which when executed by the processor cause the processor to: retrieve the weight ID; and recover a real weight value based in part on the weight ID and a weight ID look up table.

Example 6. The apparatus of claim 5, the real weight value a 16-bit floating point weight value or a 32-bit floating point weight value.

Example 7. The apparatus of claim 5, the memory storing instructions, which when executed by the processor cause the processor to: generate an intermediate output activation based in part on a quantization function where the inputs to the quantization function are the real weight value and the input activation; and accumulate the intermediate output activations.

Example 8. The apparatus of claim 7, the quantization function to perform matrix addition operations or to perform matrix multiplication operations.

Example 9. A method, comprising: retrieving coordinates for a non-zero weight of a convolutional neural network (CNN); and generating an output activation based on the coordinates for the non-zero weight of the CNN and an input activation.

Example 10. The method of claim 9, comprising: accessing a non-zero weight location vector table to retrieve the coordinates for the non-zero weight; and retrieving a memory address associates with the non-zero weight.

Example 11. The method of claim 10, the coordinates relative to a last non-zero weight.

Example 12. The method of claim 11, the non-zero weight location vector table comprising indications of a plurality of non-zero weights, each indication comprising 1-byte.

Example 13. The method of either one of claim 10 or 12, the memory address comprising an indication of a weight identification (ID), the method comprising: retrieving the weight ID; and recovering a real weight value based in part on the weight ID and a weight ID look up table.

Example 14. The method of claim 13, the real weight value a 16-bit floating point weight value or a 32-bit floating point weight value.

Example 15. The method of any one of claim 13 or 14, comprising: generating an intermediate output activation based in part on a quantization function where the inputs to the quantization function are the real weight value and the input activation; and accumulating the intermediate output activations.

Example 16. The method of claim 15, the quantization function to perform matrix addition operations or to perform matrix multiplication operations.

Example 17. A non-transitory computer-readable storage medium comprising instructions that when executed by a computing device, cause the computing device to: retrieve coordinates for a non-zero weight of a convolutional neural network (CNN); and generate an output activation based on the coordinates for the non-zero weight of the CNN and an input activation.

Example 18. The non-transitory computer-readable storage medium of claim 17, comprising instructions that when executed by the computing device, cause the computing device to: access a non-zero weight location vector table to retrieve the coordinates for the non-zero weight; and retrieve a memory address associates with the non-zero weight.

Example 19. The non-transitory computer-readable storage medium of claim 18, the coordinates relative to a last non-zero weight.

Example 20. The non-transitory computer-readable storage medium of claim 19, the non-zero weight location vector table comprising indications of a plurality of non-zero weights, each indication comprising 1-byte.

Example 21. The non-transitory computer-readable storage medium of any one of claims 18 to 20, the memory address comprising an indication of a weight identification (ID), the medium comprising instructions that when executed by the computing device, cause the computing device to: retrieve the weight ID; and recover a real weight value based in part on the weight ID and a weight ID look up table.

Example 22. The non-transitory computer-readable storage medium of claim 21, the real weight value a 16-bit floating point weight value or a 32-bit floating point weight value.

Example 23. The non-transitory computer-readable storage medium of any one of claim 21 or 22, comprising instructions that when executed by the computing device, cause the computing device to: generate an intermediate output activation based in part on a quantization function where the inputs to the quantization function are the real weight value and the input activation; and accumulate the intermediate output activations.

Example 24. The non-transitory computer-readable storage medium of claim 23, the quantization function to perform matrix addition operations or to perform matrix multiplication operations.

Example 25. A system comprising: a first processor to retrieve coordinates for a non-zero weight of a convolutional neural network (CNN); and at least a second processor to generate an output activation based on the coordinates for the non-zero weight of the CNN and an input activation.

Example 26. The system of claim 25, the first processor to: access a non-zero weight location vector table to retrieve the coordinates for the non-zero weight; and retrieve a memory address associates with the non-zero weight.

Example 27. The system of claim 26, the coordinates relative to a last non-zero weight. Example 28. The system of claim 27, the non-zero weight location vector table comprising indications of a plurality of non-zero weights, each indication comprising 1-byte.

Example 29. The system of any one of claims 26 to 28, the memory address comprising an indication of a weight identification (ID), the first processor to: retrieve the weight ID; and recover a real weight value based in part on the weight ID and a weight ID look up table.

Example 30. The system of claim 29, the real weight value a 16-bit floating point weight value or a 32-bit floating point weight value.

Example 31. The system of claim 30, the at least the second processor to: generate an intermediate output activation based in part on a quantization function where the inputs to the quantization function are the real weight value and the input activation; and accumulate the intermediate output activations.

Example 32. The system of claim 31, the quantization function to perform matrix addition operations or to perform matrix multiplication operations.

Example 33. An apparatus comprising: means to retrieve coordinates for a non-zero weight of a convolutional neural network (CNN); and means to generate an output activation based on the coordinates for the non-zero weight of the CNN and an input activation.

Example 33. The apparatus of claim 33, comprising: means to access a non-zero weight location vector table to retrieve the coordinates for the non-zero weight; and means to retrieve a memory address associates with the non-zero weight.

Example 34. The apparatus of claim 33, the coordinates relative to a last non-zero weight.

Example 35. The apparatus of claim 34, the non-zero weight location vector table comprising indications of a plurality of non-zero weights, each indication comprising 1-byte.

Example 36. The apparatus of either one of claim 33 or 35, the memory address comprising an indication of a weight identification (ID), the apparatus comprising: means to retrieve the weight ID; and means to recover a real weight value based in part on the weight ID and a weight ID look up table.

Example 37. The apparatus of claim 36, the real weight value a 16-bit floating point weight value or a 32-bit floating point weight value.

Example 38. The apparatus of any one of claim 36 or 37, comprising: means to generate an intermediate output activation based in part on a quantization function where the inputs to the quantization function are the real weight value and the input activation; and means to accumulate the intermediate output activations.

Example 39. The apparatus of claim 38, the quantization function to perform matrix addition operations or to perform matrix multiplication operations.

1. An apparatus, comprising:
a processor; and
a memory storing instructions, which when executed by the processor cause the processor to:
retrieve coordinates for a non-zero weight of a convolutional neural network (CNN); and
generate an output activation based on the coordinates for the non-zero weight of the CNN and an input activation.

2. The apparatus of claim 1, the memory storing instructions, which when executed by the processor cause the processor to:
access a non-zero weight location vector table to retrieve the coordinates for the non-zero weight; and
retrieve a memory address associates with the non-zero weight.

3. The apparatus of claim 2, the coordinates relative to a last non-zero weight.

4. The apparatus of claim 3, the memory address comprising an indication of a weight identification (ID), the memory storing instructions, which when executed by the processor cause the processor to:
retrieve the weight ID; and
recover a real weight value based in part on the weight ID and a weight ID look up table.

5. The apparatus of claim 4, the real weight value a 16-bit floating point weight value or a 32-bit floating point weight value.

6. The apparatus of claim 4, the memory storing instructions, which when executed by the processor cause the processor to:
generate an intermediate output activation based in part on a quantization function where the inputs to the quantization function are the real weight value and the input activation; and
accumulate the intermediate output activations.

7. The apparatus of claim 6, the quantization function to perform matrix addition operations or to perform matrix multiplication operations.

8. A method, comprising:
retrieving coordinates for a non-zero weight of a convolutional neural network (CNN); and
generating an output activation based on the coordinates for the non-zero weight of the CNN and an input activation.

9. The method of claim 8, comprising:
accessing a non-zero weight location vector table to retrieve the coordinates for the non-zero weight; and
retrieving a memory address associates with the non-zero weight.

10. The method of claim 9, the coordinates relative to a last non-zero weight.

11. The method of claim 9, the memory address comprising an indication of a weight identification (ID), the method comprising:
retrieving the weight ID; and
recovering a real weight value based in part on the weight ID and a weight ID look up table.

12. The method of claim 11, the real weight value a 16-bit floating point weight value or a 32-bit floating point weight value.

13. The method of claim 11, comprising:
generating an intermediate output activation based in part on a quantization function where the inputs to the quantization function are the real weight value and the input activation; and
accumulating the intermediate output activations.

14. The method of claim 13, the quantization function to perform matrix addition operations or to perform matrix multiplication operations.

15. A non-transitory computer-readable storage medium comprising instructions that when executed by a computing device, cause the computing device to:
retrieve coordinates for a non-zero weight of a convolutional neural network (CNN); and
generate an output activation based on the coordinates for the non-zero weight of the CNN and an input activation.

16. The non-transitory computer-readable storage medium of claim 15, comprising instructions that when executed by the computing device, cause the computing device to:
access a non-zero weight location vector table to retrieve the coordinates for the non-zero weight; and
retrieve a memory address associates with the non-zero weight.

17. The non-transitory computer-readable storage medium of claim 16, the memory address comprising an indication of a weight identification (ID), the medium comprising instructions that when executed by the computing device, cause the computing device to:
retrieve the weight ID; and
recover a real weight value based in part on the weight ID and a weight ID look up table.

18. The non-transitory computer-readable storage medium of claim 17, comprising instructions that when executed by the computing device, cause the computing device to:
generate an intermediate output activation based in part on a quantization function where the inputs to the quantization function are the real weight value and the input activation; and
accumulate the intermediate output activations.

19. A system comprising:
a first processor to retrieve coordinates for a non-zero weight of a convolutional neural network (CNN); and
at least a second processor to generate an output activation based on the coordinates for the non-zero weight of the CNN and an input activation.

20. The system of claim 19, the first processor to:
access a non-zero weight location vector table to retrieve the coordinates for the non-zero weight; and
retrieve a memory address associates with the non-zero weight.

21. The system of claim 20, the memory address comprising an indication of a weight identification (ID), the first processor to:
retrieve the weight ID; and
recover a real weight value based in part on the weight ID and a weight ID look up table.

22. The system of claim 21, the at least the second processor to:
generate an intermediate output activation based in part on a quantization function where the inputs to the quantization function are the real weight value and the input activation; and
accumulate the intermediate output activations.
